(19) United States
(12) Patent Application Publication
(10) Pub. No.: US 2024/0017280 A1
(43) Pub. Date: Jan. 18, 2024

(54) FOAM PUMP INDEPENDENT OF SPRING SEALING

(71) Applicant: GUANGZHOU LIGAO PLASTIC PRODUCTS CO., LTD., Guangzhou City (CN)

(72) Inventor: Jianlei HUANG, Guangzhou City (CN)

(21) Appl. No.: 18/350,426

(22) Filed: Jul. 11, 2023

Related U.S. Application Data
(63) Continuation of application No. PCT/CN2022/109848, filed on Aug. 3, 2022.

(30) Foreign Application Priority Data
Jul. 13, 2022 (CN) 202210828818.7

(51) Int. Cl. B05B 11/10

(52) U.S. Cl. CPC B05B 11/105; B05B 11/1001; B05B 11/1077; B05B 11/1074

(57) ABSTRACT

A foam pump independent of spring sealing includes a gland, a connecting part, a moving part, an outer cover, an inner core, a piston, a middle sheath, a piston seat, an outer case, a bead, a spring and a straw. The gland can rotate relative to the outer cover, and is connected with the moving part located in the gland; the connecting part is fixed in an inner cavity of the gland; one end of the inner core away from the moving part extends into an inner cavity of the piston, and is movably connected with a sealing assembly on the piston along with the piston seat. The foam pump independent of spring sealing can prevent the liquid from being squeezed, and can also increase the service life of the spring and improve product competitiveness and user experience.

### CROSS REFERENCE TO RELATED APPLICATIONS

This application is a Continuation of the U.S. National Stage of International Application No. PCT/CN2022/109848 filed on Aug. 3, 2022, which claims priority to Chinese Patent Application No. 202210828818.7 on filed Jul. 13, 2022 under 35 U.S.C. § 119, the entire contents of all of which are hereby incorporated by reference.

### TECHNICAL FIELD

The present application relates to the technical field of foam pumps, and in particular to a foam pump independent of spring sealing.

### BACKGROUND

Body wash products, such as those used in daily life, generally comprise a foam pump and a container. The container contains body wash liquid, and the foam pump is installed on the container. Before the body wash product is unsealed and used by a consumer, including the process of transportation and on a goods shelf, the foam pump needs to be always in a sealed state to prevent the liquid from being squeezed due to unexpected events. To achieve that the foam pump is in a sealed state, the frequently-used foam pump depends on an extension spring to support relevant sealing elements in the foam pump. Because the spring is in an extended state for a long time, it is easy to cause deformation and fatigue damage to the spring, and then reduce the service life of the spring, especially when the spring uses a plastic spring, the service life is more obviously affected.

Most of the existing foam pumps depend on the spring to achieve sealing. In the foam pump, the spring is in the extended state to support a sealing assembly in the foam pump, so that the sealing assembly is in a sealed state to prevent the liquid in the container which is connected with the foam pump from being squeezed from the foam pump. For example, Chinese invention application patent with publication No. CN112249501A depends on a return spring abutted between the lower end surface of a column head and the upper end surface of a spring seat to achieve sealing. The return spring is affected by the extrusion force from two ends of the column head and the spring seat to the middle, that is, the spring is in a certain extended (tensioned) state and affected by the force, thereby reducing the impact of the spring. Thus, it is necessary to achieve sealing independently of the spring and the functions of foam pressing and resetting by the spring, and to achieve the sealing function and at the same time, without affecting the functions of the spring to achieve downward foam pressing and resetting.

### SUMMARY

In view of the defects in the prior art, the purpose of the present application is to provide a foam pump independent of spring sealing, which can solve the problem that the existing foam depends on a spring to realize sealing.

A technical solution for achieving the purpose of the present application is: a foam pump independent of spring sealing comprises a gland, a connecting part, a moving part, an outer cover, an inner core, an outer case, a spring and a straw; the outer case is provided with an inner column; the gland can rotate relative to the outer cover, and is connected with the moving part located in the gland; an upper end of the moving part is connected with the connecting part; the connecting part is fixed in an inner cavity of the gland; a lower end of the moving part is connected with the inner core; one end of the inner core away from the moving part extends into an inner cavity of the inner column, and is movably connected with a sealing assembly on the inner column; the spring is sleeved on the inner column of the outer case.

The gland rotates to a first position, and the sealing assembly is used for hermetically connecting an inner cavity of the inner core with the inner cavity of the inner column to prevent liquid from entering the inner cavity of the inner core from the inner cavity of the inner column, to prevent the liquid from being squeezed.

The first position: the gland is in a state of limited sliding along the axial direction of the outer cover and is kept in circumferential rotation with the outer cover.

Further, one end of the gland penetrates through a through hole at an upper end of the outer cover and extends into an inner cavity of the outer cover, and one end of the gland that extends into the inner cavity of the outer cover is connected with the moving part through a buckle.

Further, the first position further comprises that the spring is sleeved on the inner column of the outer case in a state of unstressed freedom.

Further, the gland firstly rotates to an upper part of a second position, then moves along an axial direction near the outer cover for a distance, and rotates from the first position to the second position; the gland is in the state of the second position; and both ends of the spring are abutted against an upper end of the inner core and a lower end of the outer case respectively.

The second position: the gland can slide along the axial direction of the outer cover and is limited in circumferential rotation relative to the outer cover.

Further, one side of the through hole of the outer cover is provided with a locking port; side edges of both ends of the locking port are provided with an inclined locking edges; the gland is provided with a lock pillar strip matched with the locking port; a lower end of the lock pillar strip is matched with the inclined locking edges and can be completely abutted against the inclined locking edges; and when the gland is in the first position, the lock pillar strip is away from the locking port and the lower end of the lock pillar strip is abutted against an edge of the through hole at an upper end of the gland.

Further, the inclined locking edges are arranged downward obliquely towards a long column body.

Further, the sealing assembly comprises a middle sheath, a piston seat and a piston; the middle sheath is located at an upper end of the inner column and is embedded into the inner column; a lower end of the inner core extends into the piston seat; one end of the piston embedded into an inner cavity of the piston seat is abutted against a lower end of the middle sheath; the middle sheath is fixed to a lower end of the inner core of the inner cavity of the outer case and is in spaced connection with the piston; and when the gland is in the state of the first position, the piston slides towards the piston seat, so that an lower end of an inner cavity of the piston is abutted against and hermetically connected with a bevel of the piston seat, to hermetically connect the inner cavity of the piston and the inner cavity of the piston seat, to realize the hermetical connection of an inner cavity of the inner core and the inner cavity of the inner column.

Further, a lower end of the piston is movably abutted against an inner wall of a piston seat, so that the piston can slide up and down along the axial direction of the piston seat for a distance.

Further, the middle of the lower end of the moving part is provided with a notch, and the upper end of the inner core is fixed in the notch and fixedly connected with the moving part.

Further, the upper end of the inner core is provided with a circumferential groove, and the spring is abutted against or is in spaced connection with the circumferential groove.

Further, one end of the piston extends into the inner cavity of the piston seat, the piston can slide along the axial direction of the piston seat, and the other end is located in the inner cavity of the bevel of the piston seat.

The present application has the beneficial effects: the present application makes the gland in a locking state to convert the original communication state into a sealing state at the connection between the long column body and the inner column, to prevent the liquid from being squeezed; and the spring is in a normal and undeformed state, which avoids accidental squeezing of the liquid, ensures the service life of the spring and improves product competitiveness and user experience.

### DESCRIPTION OF DRAWINGS

FIG. 1 is a sectional view of the present application when a spring is removed;

FIG. 2 is a sectional view when a gland is removed and a spring is provided;

FIG. 3 is a structural schematic diagram of a spring;

FIG. 4 is a structural schematic diagram of another spring;

FIG. 5 is a sectional view from another perspective;

FIG. 6 is a three-dimensional structural schematic diagram when a gland is removed;

FIG. 7 is a structural schematic diagram of an outer cover;

FIG. 8 shows assembly among a gland, a moving part and a long column body;

FIG. 9 is a schematic diagram of a state that a lock pillar strip of a gland is abutted against the edge of a through hole of an outer cover;

FIG. 10 is a structural schematic diagram of locking with a clip;

FIG. 11 is an enlarged schematic view of a portion A in FIG. 2;

In the figures, 1—gland, 101—lock pillar strip, 2—connecting part, 3—moving part, 4—outer cover, 41—locking port, 42—inclined locking edge, 5—inner core, 6—piston, 7—middle sheath, 8—piston seat, 9—outer case, 10—bead, 11—straw, 12—spring, 13—clip, 14—through hole of the outer cover, 15—notch, 16—long column body, 17—groove, 18—inner column, 19—through hole of piston, 20—bevel.

### DETAILED DESCRIPTION

The present application is further described below in combination with drawings and specific embodiments.

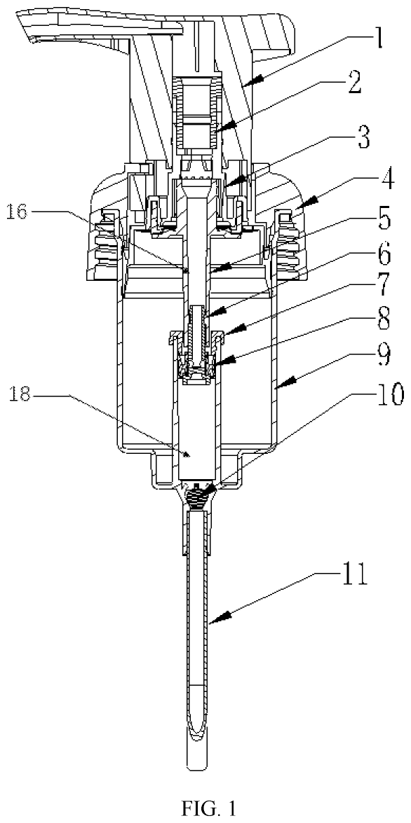

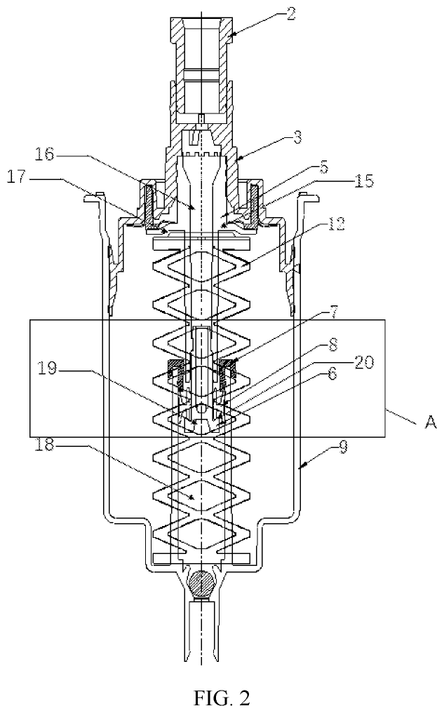

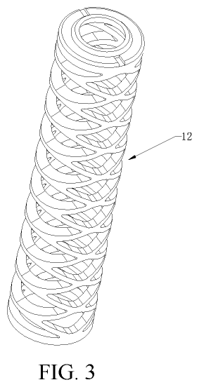

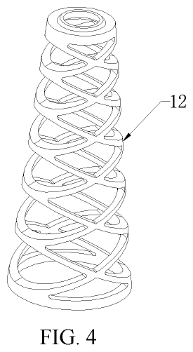

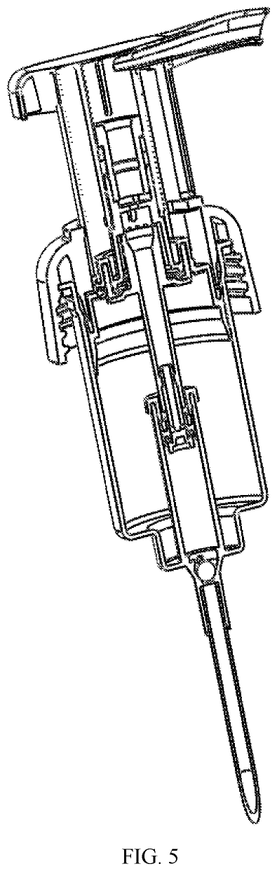

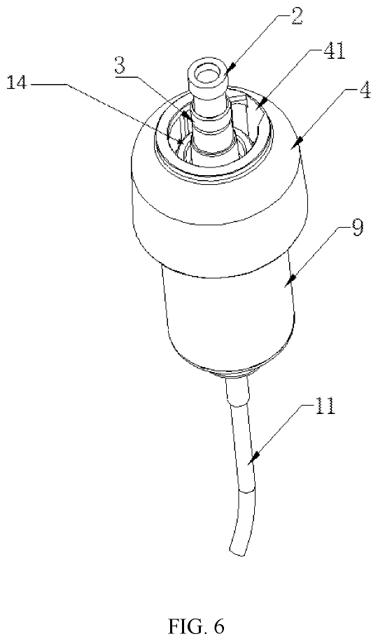

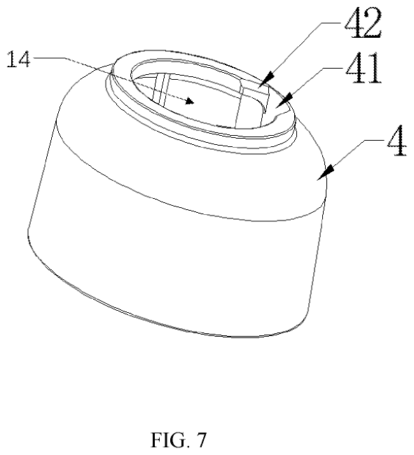

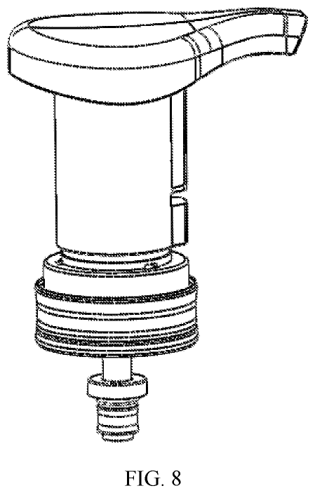

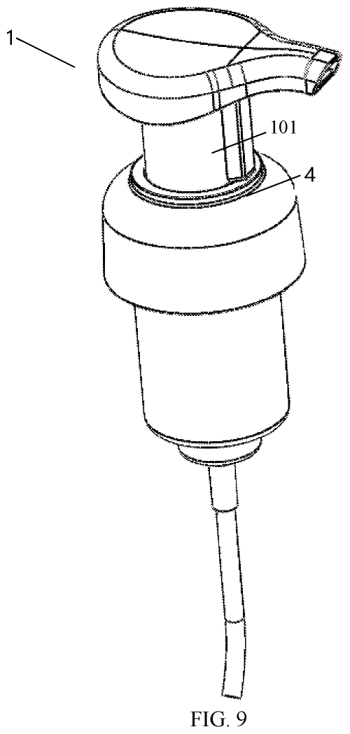

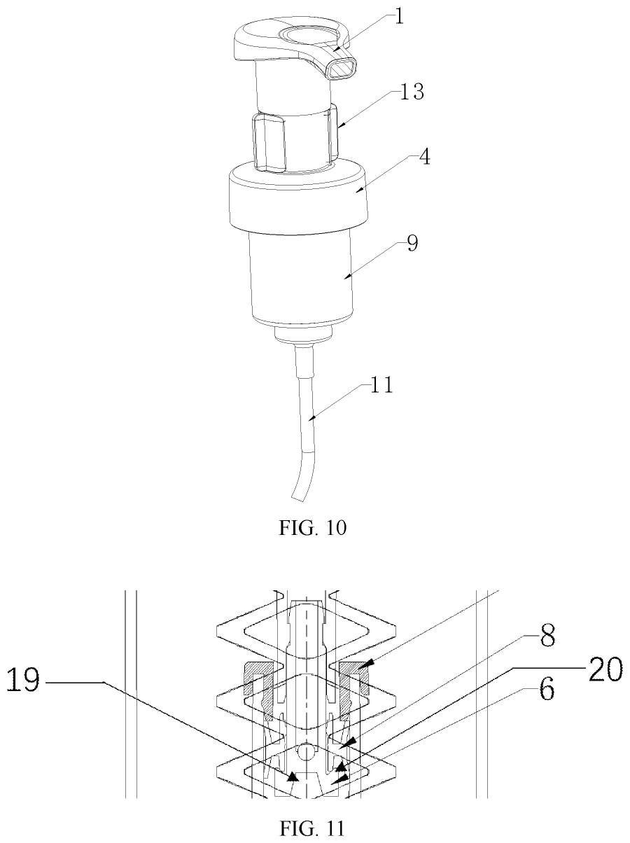

As shown in FIG. 1-FIG. 10, a foam pump independent of spring 12 sealing comprises a gland 1, a connecting part 2, a moving part 3, an outer cover 4, an inner core 5, a piston 6, a spring 12, an outer case 9 and a straw 11. One end of the gland 1 penetrates through a through hole 14 at an upper end of the outer cover 4 and extends into an inner cavity of the outer cover 4, and one end of the gland 1 that extends into the inner cavity of the outer cover 4 is connected with an upper end of the moving part 3 through a buckle so that the gland 1 can be disassembled from the moving part 3. The gland 1 is between the upper end of the moving part 3 and the outer cover 4; the upper end of the moving part 3 is connected with the connecting part 2; and the connecting part 2 is fixed in an inner cavity of the gland 1. A lower end of the moving part 3 is abutted against an inner wall of the outer case 9, and the moving part 3 can slide up and down along the axial direction (i.e., vertical direction) of the outer case 9. The middle of the lower end of the moving part 3 is provided with a notch 15, an upper end of a long column body 16 arranged on the inner core 5 is fixed in the notch 15 and fixedly connected with the moving part 3, and the moving part 3 can rotate relative to the long column body 16. Namely, while the moving part 3 is fixedly connected with the long column body 16 in the vertical direction, the moving part 3 can rotate in the circumferential direction of the long column body 16. The spring 12 is sleeved on the inner core 5. An upper end of the spring 12 is abutted against or spaced in a circumferential groove at the upper end of the long column body 16. The circumferential groove is arranged at the upper end of the long column body 16 near the notch 15. An lower end of the spring 12 is sleeved on an inner column 18 arranged in the outer case 9 and then is abutted against a bottom of the outer case 9. The inner column 18 is fixed in an inner cavity of the outer case 9.

Before the gland 1 is pressed, the spring 12 sleeved on the long column body 16 and the inner column 18 is in a state of unstressed freedom, that is, the spring 12 is not stressed and thus is not deformed. At this time, whether the spring 12 is in contact with the long column body 16 and the outer case 9, the spring 12 is not subjected to extrusion force and is not deformed. Of course, in actual use, the spring 12 can also be sleeved only on the inner column 18.

One side of the through hole 14 on the outer cover 4 is provided with a locking port 41; side edges of both ends of the locking port 41 are provided with inclined locking edges 42; and the inclined locking edges 42 are arranged downward obliquely towards the long column body 16. The gland 1 is provided with a lock pillar strip 101 matched with the locking port 41; and a lower end of the lock pillar strip 101 is matched with the inclined locking edges 42 and can be completely abutted against the inclined locking edges 42. When the gland 1 rotates to a second position, the lock pillar strip 101 is located in the locking port 41 and the lower end of the lock pillar strip 101 is abutted against the inclined locking edges 42. The gland 1 located in the second position cannot rotate relative to the outer cover 4. That is, at this moment, the gland 1 is prohibited from rotating on the outer cover 4 (that is, the circumferential freedom of rotation of the gland 1 on the outer cover 4 is limited), that is, prohibited from rotating in the circumferential direction, but the gland 1 can slide up and down axially relative to the outer cover 4. Thus, the liquid in a container bottle can be finally squeezed from the gland 1 by pressing the gland 1. When the gland is located in other positions except the second position, the position reached by the gland 1 except the second position is recorded as a first position. The lock pillar strip 101 is located outside the notch 15, and the lower end of the lock pillar strip 101 is abutted against an edge of a through hole 14 at an upper end of the gland 1, so that the gland 1 can rotate freely, but the gland 1 cannot slide up and down axially relative to the outer cover 4, so as to avoid pressing the gland 1 and squeezing the liquid. That is, the gland 1 in the first position is prohibited from sliding along the axial direction of the outer cover 4 and can rotate along the circumferential direction of the outer cover 4. When the gland 1 rotates from the first position to the second position and the gland 1 is in the state of the second position, both ends of the spring 12 are abutted against the upper end of the long column body 16 and the outer case 9 respectively. At this time, because the gland 1 rotates in the direction of the locking port 41 and then moves down for a distance, the lock pillar strip 101 of the gland 1 is abutted against the inclined locking edges 42, and the gland 1 drives the moving part 3 and the long column body 16 to move down for a short distance. Both ends of the spring 12 can be abutted against the upper end of the long column body 16 and the outer case 9.

The second position: the gland 1 can slide along the axial direction of the outer cover 4 and is prohibited from conducting circumferential rotation relative to the outer cover 4.

When the gland 1 rotates to the second position, the gland 1 pulls the long column body 16 upward so that the piston 6 connected with the long column body 16 also reaches a third position. At this time, the piston 6 blocks the long column body 16 for sealing and isolation, that is, the inner cavity of an inner column 18 and an inner cavity of the long column body 16 are in a hermetical connection state instead of the original communication state, so that the liquid in the container bottle cannot enter the inner cavity of the long column body 16 through the straw 11 and the inner column 18, and then cannot be squeezed from a liquid extrusion channel of the gland 1 finally through the inner cavity of the long column body 16, so as to prevent the liquid from being squeezed by accident during transportation or placement.

The gland 1 rotates from the first position to the second position. Firstly, the gland 1 rotates to the position of the locking port 41 and then moves in the direction of the outer cover 4 (that is, pressed down) for a distance so that the gland 1 can be switched from the first position to the second position. In turn, when the gland 1 needs to be switched from the second position to the first position, the gland 1 is lifted upward for a distance, and after the gland 1 is pulled out from the locking port 41, the gland 1 rotates and is abutted against an upper edge of the outer cover 4 to switch to the first position.

A lower end of the long column body 16 extends into the inner cavity of the inner column 18 and is fixedly connected with the piston 6 located in the inner cavity of the inner column 18. One end of the piston 6 extends into the inner cavity of the long column body 16, the piston 6 can slide along the axial direction of the long column body 16, and the other end of the piston 6 is located in the inner cavity of the inner column 18. An upper end of the inner column 18 is fixedly provided with a middle sheath 7; the middle sheath 7 is embedded on the inner column 18; the lower end of the long column body 16 extends into the middle sheath 7; one end of the middle sheath 7 embedded into the inner cavity of the inner column 18 is abutted against an upper end of the piston 6; the piston 6 is fixed in the inner cavity of the inner column 18; the piston seat 8 can be abutted and sealed on an inner wall of the inner column 18 through tightening, and is fixed on the inner column 18; the piston seat 8 always maintains hermetical contact with the inner wall of the inner column 18; a lower end of the piston 6 is in spaced connection with the piston seat 8; and the upper end of the piston 6 is abutted against an outer wall of the piston seat 8 to achieve abutted sealing. The piston 6 can slide along the axial direction of the piston seat 8, and when the piston 6 slides towards the direction of the long column body 16 to the third position, the piston seat 8 and the piston 6 are abutted and hermetically connected. A through hole 19 communicated with the inner cavity of the long column body 16 is arranged in the piston 6. When a bevel 20 of the lower end of the piston 6 is in contact with the piston seat 8, the piston 6 maintains hermetical contact with the piston seat 8, and the cavity body of the inner column 18 is thus disconnected from the cavity body of the long column body 16 and is in a hermetical connection state. When the bevel 20 of the lower end of the piston 6 is out of contact with the piston seat 8 and is in a spaced state, although the upper end of the piston 6 is still in hermetical abutted connection with the piston seat 8, the lower end of the piston 6 is communicated with a lower end of the piston seat 8 (that is, a spaced gap is reserved), thus, the piston 6 and the piston seat 8 are in a communicated state. The liquid in the cavity body of the inner column 18 flows into the through hole 19 of the piston 6 through the gap between the piston 6 and the piston seat 8, and the liquid flowing out of the through hole 19 flows into the cavity body of the long column body 16 and finally flows out of the gland 1.

A lower end of the outer case 9 is in communication connection with the straw 11, a bead 10 is arranged at the connection of the outer case 9 and the straw 11, and the bead 10 is used for preventing the liquid absorbed by the straw 11 from entering the inner cavity of the inner column 18 under normal conditions.

In practical application, when transported or placed on a goods shelf, the foam pump is fixedly installed in the container bottle through the outer cover 4, for example, a frequently-used bottled body wash, and the straw 11 extends into the liquid inside the container bottle. Before use by consumers, the gland 1 is pulled up for a short distance and then the gland 1 rotates so that the gland 1 enters the second position. At this time, the gland 1 cannot rotate relative to the outer cover 4. The gland 1 is pulled up for a distance under the action of external force, and then the long column body 16 is pulled up for a distance by the moving part 3. The long column body 16 drives the piston 6 to move up for a short distance, so that the piston 6 and the piston seat 8 are in hermetical abutted connection, that is, the piston 6 reaches the third position, so that the liquid cannot enter the inner cavity of the long column body 16 from the straw 11, and then the liquid cannot eventually flow out of the gland 1. Thus, the liquid may not be accidentally squeezed before unsealing and formal use by the consumers including transportation or placement in the goods shelf. Moreover, while preventing the liquid from being squeezed by accident, the spring 12 is always in a normal state, neither extended nor compressed, and the spring 12 is completely in an undeformed state, so that the service life of the spring 12 may not be affected.

When in use, the gland 1 is only rotated so that the gland 1 enters the first position to press the gland 1. At this time, the piston 6 is away from the third position, and the piston 6 and the piston seat 8 are spaced at a gap. The liquid absorbed from the straw 11 flows into the inner cavity of the inner column 18, and then flows into the inner cavity of the long column body 16 from the gap, so that the liquid can be finally squeezed through the gland 1.

The above gland 1 is matched with the locking port 41 on the outer cover 4 by the lock pillar strip 101, so that the gland 1 can be rotated to the first position and the second position. In another alternative embodiment, the gland 1 may realize the same effect in the first position and the second position through a clip 13. That is, when the clip 13 is buckled between the gland 1 and the outer cover 4, the gland 1 is pulled upward by a distance so that the long column body 16 and the inner column 18 are hermetically connected. After the clip 13 is removed, the gland 1 moves down by a distance, and the long column body 16 and the inner column 18 are kept in a communication state. Due to the fixing effect of the clip 13, when the clip 13 acts on the gland 1, although the gland 1 can be rotated in the circumferential direction, the liquid can also be prevented from being squeezed.

The present application makes the gland 1 in a locking state to convert the original communication state into a sealing state at the connection between the long column body 16 and the inner column 18, to prevent the liquid from being squeezed; and the spring 12 is in a normal and undeformed state, which avoids accidental squeezing of the liquid, ensures the service life of the spring 12 and improves product competitiveness and user experience.

The embodiment disclosed in this description is only an example of unilateral features of the present application, and the protection scope of the present application is not limited to this embodiment. Any other functionally equivalent embodiment falls within the protection range of the present application. For those skilled in the art, various other corresponding changes and modifications can be made according to the technical solution and concept described above, and all these changes and modifications should fall within the protection scope of the claims of the present application.

1. A foam pump independent of spring sealing, comprising a gland, a connecting part, a moving part, an outer cover, an inner core, an outer case, a spring and a straw, wherein the outer case is provided with an inner column; the gland can rotate relative to the outer cover, and is connected with the moving part located in the gland; an upper end of the moving part is connected with the connecting part; the connecting part is fixed in an inner cavity of the gland; a lower end of the moving part is connected with the inner core; one end of the inner core away from the moving part extends into an inner cavity of the inner column, and is movably connected with a sealing assembly on the inner column; the spring is sleeved on the inner column of the outer case;
the gland rotates to a first position, and the sealing assembly is used for hermetically connecting an inner cavity of the inner core with the inner cavity of the inner column to prevent liquid from entering the inner cavity of the inner core from the inner cavity of the inner column, to prevent the liquid from being squeezed;
the first position: the gland is in a state of limited sliding along the axial direction of the outer cover and is kept in circumferential rotation with the outer cover.

2. The foam pump independent of spring sealing according to claim 1, wherein one end of the gland penetrates through a through hole at an upper end of the outer cover and extends into an inner cavity of the outer cover, and one end of the gland that extends into the inner cavity of the outer cover is connected with the moving part through a buckle.

3. The foam pump independent of spring sealing according to claim 1, wherein the first position further comprises that the spring is sleeved on the inner column of the outer case in a state of unstressed freedom.

4. The foam pump independent of spring sealing according to claim 3, wherein the gland firstly rotates to an upper part of a second position, then moves along an axial direction near the outer cover for a distance, and rotates from the first position to the second position; the gland is in the state of the second position; and both ends of the spring are abutted against an upper end of the inner core and a lower end of the outer case respectively;
the second position: the gland can slide along the axial direction of the outer cover and is limited in circumferential rotation relative to the outer cover.

5. The foam pump independent of spring sealing according to claim 3, wherein one side of the through hole of the outer cover is provided with a locking port; side edges of both ends of the locking port are provided with an inclined locking edges; the gland is provided with a lock pillar strip matched with the locking port; a lower end of the lock pillar strip is matched with the inclined locking edges and can be completely abutted against the inclined locking edges; and when the gland is in the first position, the lock pillar strip is away from the locking port and the lower end of the lock pillar strip is abutted against an edge of the through hole at an upper end of the gland.

6. The foam pump independent of spring sealing according to claim 5, wherein the inclined locking edges are arranged downward obliquely towards a long column body.

7. (canceled)

8. (canceled)

9. (canceled)

10. (canceled)

11. (canceled)

12. The foam pump independent of spring sealing according to claim 1, wherein the sealing assembly comprises a middle sheath, a piston seat and a piston; the middle sheath is located at an upper end of the inner column and is embedded into the inner column; a lower end of the inner core extends into the piston seat; one end of the piston embedded into an inner cavity of the piston seat is abutted against a lower end of the middle sheath; the middle sheath is fixed to a lower end of the inner core of the inner cavity of the outer case and is in spaced connection with the piston; and when the gland is in the state of the first position, the piston slides towards the piston seat, so that an lower end of an inner cavity of the piston is abutted against and hermetically connected with a bevel of the piston seat, to hermetically connect the inner cavity of the piston and the inner cavity of the piston seat, to realize the hermetical connection of an inner cavity of the inner core and the inner cavity of the inner column.

13. The foam pump independent of spring sealing according to claim 12, wherein a lower end of the piston is movably abutted against an inner wall of a piston seat, so that the piston can slide up and down along the axial direction of the piston seat for a distance.

14. The foam pump independent of spring sealing according to claim 13, wherein the middle of the lower end of the moving part is provided with a notch, and the upper end of the inner core is fixed in the notch and fixedly connected with the moving part.

15. The foam pump independent of spring sealing according to claim 14, wherein the upper end of the inner core is provided with a circumferential groove, and the spring is abutted against or is in spaced connection with the circumferential groove.

16. The foam pump independent of spring sealing according to claim 12, wherein one end of the piston extends into the inner cavity of the piston seat, the piston can slide along the axial direction of the piston seat, and the other end is located in the inner cavity of the bevel of the piston seat.
